(19) United States
(12) Patent Application Publication
(10) Pub. No.: US 2018/0010704 A1
(43) Pub. Date: Jan. 11, 2018

(54) Pressure Relief Ball Valve

(71) Applicant: Ryuji Mitsuoka, Bellevue, WA (US)

(72) Inventor: Ryuji Mitsuoka, Bellevue, WA (US)

(21) Appl. No.: 15/713,398

(22) Filed: Sep. 22, 2017

Related U.S. Application Data
(63) Continuation-in-part of application No. 15/157,660, filed on May 18, 2016.
(60) Provisional application No. 62/398,021, filed on Sep. 22, 2016.
(60) Provisional application No. 62/169,584, filed on Jun. 2, 2015.

(51) Int. Cl. F16K 17/20; F16K 31/60; F16K 5/06

(52) U.S. Cl. CPC F16K 17/20; F16K 5/0605; F16K 31/602

(57) ABSTRACT

A pressure relief ball valve to prevent excessive pressure buildup due to freezing liquid includes a ball that is rotatably housed within a valve body. A fluid conduit traverses through the ball, wherein rotation of the ball via a lever handle either aligns or disjoints the fluid conduit with an inlet and an outlet of the valve body. Meanwhile, a drain hole traverses into the ball and intersects the fluid conduit. When the ball is toggled to an open position, the drain hole is positioned adjacent to a side wall of the valve body, such that the drain hole is capped off. When the ball is toggled to a closed position, the drain hole is positioned adjacent to the outlet, wherein residual liquid is expelled from the fluid conduit. The removal of residual liquid prevents excessive pressure buildup due to freezing liquid within the valve body.

The current application claims a priority to the U.S. Provisional Patent application Ser. No. 62/398,021 filed on Sep. 22, 2016.

### FIELD OF THE INVENTION

The present invention relates generally to valves. More specifically, the present invention is a pressure relief ball valve to prevent excessive pressure buildup due to freezing liquid.

### BACKGROUND OF THE INVENTION

Ball valves use a common design of a ball that has a drain hole bored in the middle, and the ball is sandwiched between two Teflon seals. When the valve is closed, the seals hold the ball with the drain hole perpendicular to the flow direction, so the content will not flow. When the valve is opened by turning the ball with the attached lever, the drain hole is in line with the flow direction, so the content (liquid or air) will flow freely.

When the valve is closed when no liquid is flowing through the drain hole (such as after draining the liquid from a tank) there will be nothing left inside the valve—no issues. However, if the valve is closed while the liquid is still flowing through the drain hole, the liquid will be trapped inside the round cavity of the ball. the trapped liquid will further drain out to the inside cavity of the valve structure, as there are a few small chambers in the valve. This will do no harm to the valve, but when the valve is subjected to extreme low temperature, the liquid trapped inside the valve cavity would freeze and increase its mass volume, causing the pressure to build up and possibly affecting the seal.

Therefore, it is an objective of the present invention to provide a pressure relief ball valve to prevent excessive pressure buildup due to freezing liquid. The present invention comprises a ball that is rotatably housed within a valve body, wherein rotation of the ball either aligns or disjoints a fluid conduit that traverses through the ball with an inlet and an outlet of the valve body. Meanwhile, a drain hole traverses into the ball and intersects the fluid conduit. When the ball is toggled to an open position, the drain hole is positioned adjacent to a side wall of the valve body, such that the drain hole is capped off. When the ball is toggled to a closed position, the drain hole is positioned adjacent to the outlet, wherein residual liquid is expelled from the fluid conduit. The removal of residual liquid prevents excessive pressure buildup due to freezing liquid within the valve body.

### BRIEF DESCRIPTION OF THE DRAWINGS

FIG. 1 is a perspective view of the ball, showing the fluid conduit and the drain hole.

FIG. 2 is a right side elevational view of the ball, wherein the fluid conduit traverses through the ball.

FIG. 3 is a sectional view taken along line A-A of FIG. 2, showing the drain hole traversing into the ball and intersecting with the fluid conduit.

FIG. 4 is a perspective view of the present invention, wherein the lever handle and the ball are toggled in the open position.

FIG. 5 is a right side elevational view of the present invention in the open position, wherein the fluid conduit is aligned with both the inlet and the outlet.

FIG. 6 is a sectional view taken along line A-A of FIG. 5, wherein the drain hole is offset from the outlet.

FIG. 7 is a perspective view of the present invention, wherein the lever handle and the ball are toggled in the closed position.

FIG. 8 is a right side elevational view of the present invention in the closed position, wherein the drain hole is positioned adjacent to the outlet.

FIG. 9 is a sectional view taken along line A-A of FIG. 8, wherein the drain hole is aligned with the outlet, while the fluid conduit is disjointed from the inlet and the outlet.

### DETAIL DESCRIPTIONS OF THE INVENTION

All illustrations of the drawings are for the purpose of describing selected versions of the present invention and are not intended to limit the scope of the present invention.

The present invention is a pressure relief ball valve. The present invention is an improvement over existing ball valves, in that the present invention allows residual gas and liquid to escape the ball when the valve is closed. A secondary hole is formed in the ball, wherein the secondary hole allows the residual gas or liquid to drain, in addition to relieving air pressure towards the exit side of the ball, when the valve is closed.

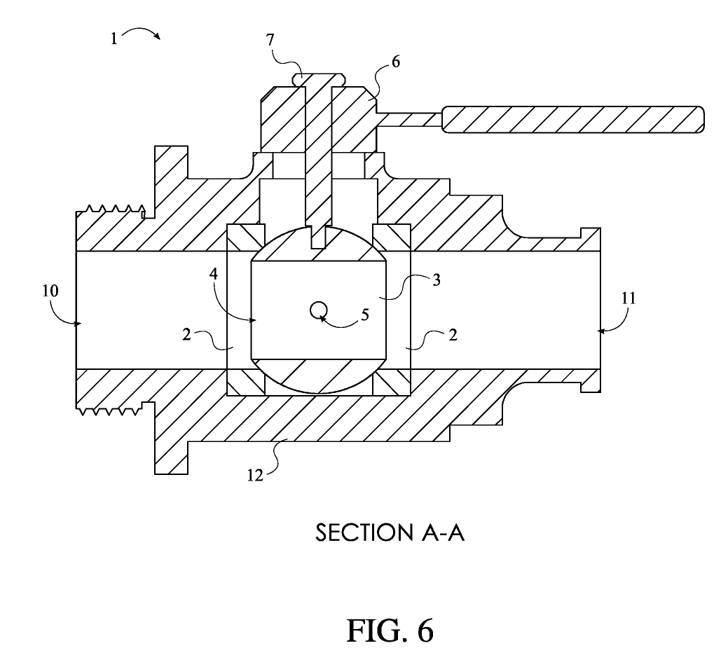

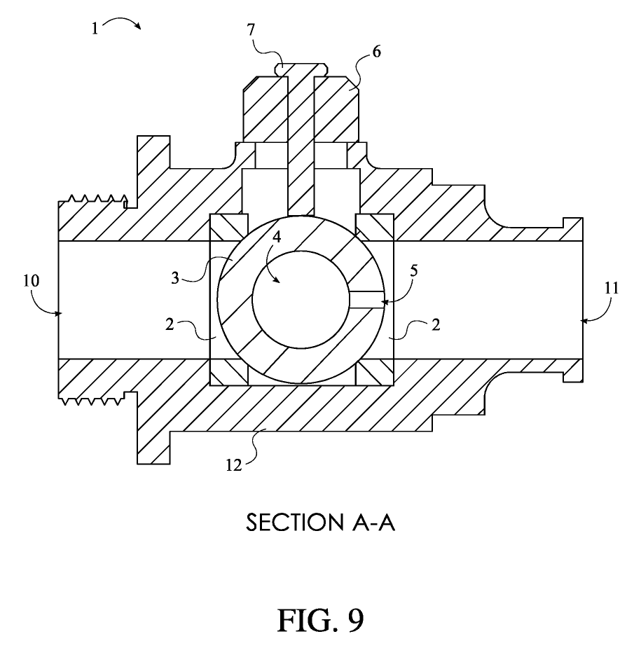

The present invention comprises a valve body 1, a seat 2, a ball 3, a fluid conduit 4, a drain hole 5, a lever handle 6, and a stem 7. The valve body 1 houses the seat 2 and the ball 3 as shown in FIG. 6 and FIG. 9, and is installed between two or more plumbing fixtures. The valve body 1 comprises an inlet 10, an outlet 11 and a valve chamber 12; the valve chamber 12 being positioned in between the inlet 10 and the outlet 11. In this way, gas or liquid traverses into the inlet 10, through the valve chamber 12, and out through the outlet 11 when the pressure relief ball valve is open.

The ball 3 is rotatably mounted within the valve chamber 12, wherein the ball 3 is configurable between an open position and a closed position. In order to toggle the ball 3 between the open position and the closed position, the lever handle 6 is operably coupled to the ball 3. The lever handle 6 is externally positioned about the valve body 1, whereas the ball 3 is internally positioned. Thus, the lever handle 6 provides a user with the means to manipulate the orientation of the ball 3 within the valve body 1.

More specifically, the ball 3 is nested in the seat 2, as shown in FIG. 6 and FIG. 9. The seat 2 is mounted within the valve chamber 12 and provides a means for supporting the ball 3, while still allowing for rotation of the ball 3. Furthermore, the seat 2 provides a seal between the ball 3 and the valve body 1 to prevent any leaks in the pressure relief ball valve. In the preferred embodiment, the seat 2 comprises a first ring and a second ring. The first ring is positioned adjacent to the inlet 10, while the second ring is positioned adjacent to the outlet 11; the ball 3 being suspended between the first ring and the second ring.

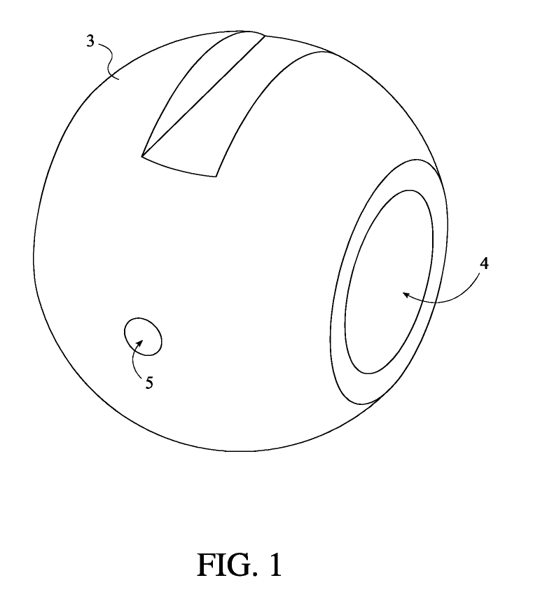

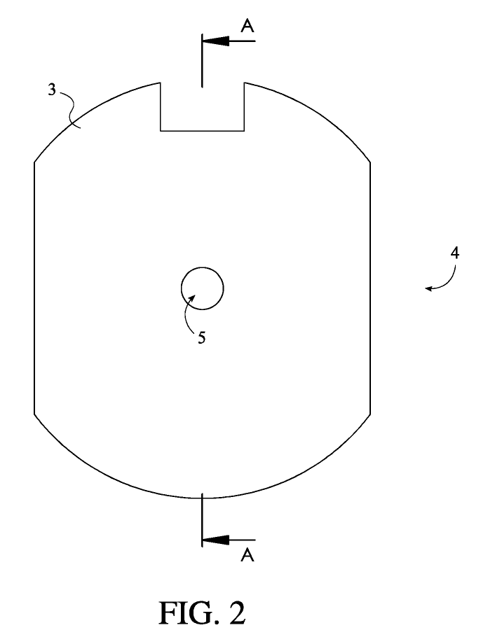

In reference to FIG. 1-3, the fluid conduit 4 traverses through the ball 3, forming an open-ended channel in the ball 3. By rotating the ball 3, the fluid conduit 4 is either aligned with the inlet 10 and the outlet 11, or disjointed from the inlet 10 and the outlet 11. When the ball 3 is toggled to the open position, the fluid conduit 4 is in fluid communication with the inlet 10 and the outlet 11 as shown in FIG. 6, wherein gas or liquid may freely traverse through the pressure relief ball valve. On the other hand, when the ball 3 is toggled to the closed position, the fluid conduit 4 is disjointed from the inlet 10 and the outlet 11 as shown in FIG. 9, wherein the ball 3 prevents gas or liquid from traversing through the valve chamber 12.

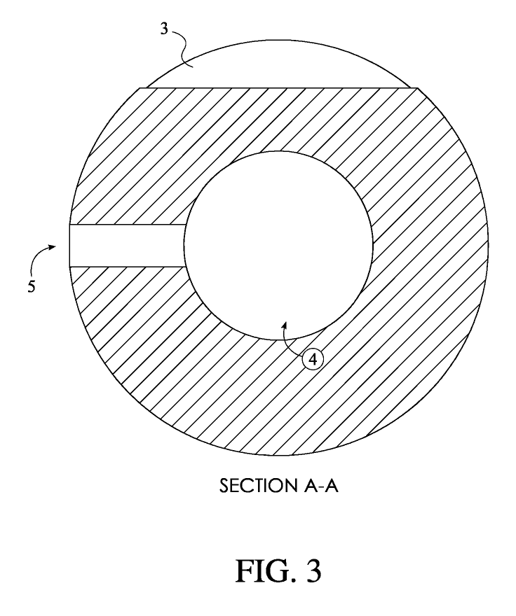

In reference to FIG. 3, the drain hole 5 traverses into the ball 3, wherein the drain hole 5 is angularly offset from the fluid conduit 4. The drain hole 5 intersects with the fluid conduit 4, such that the drain hole 5 is in fluid communication with the fluid conduit 4. In the preferred embodiment of the present invention, the drain hole 5 is oriented perpendicular to the fluid conduit 4 and intersects the fluid conduit 4 about the mid-point of the fluid conduit 4. However, in other embodiments of the present invention, the angle of the drain hole 5 in relation to the fluid conduit 4 may be different, or the location of the intersection between the drain hole 5 and the fluid conduit 4 may be different.

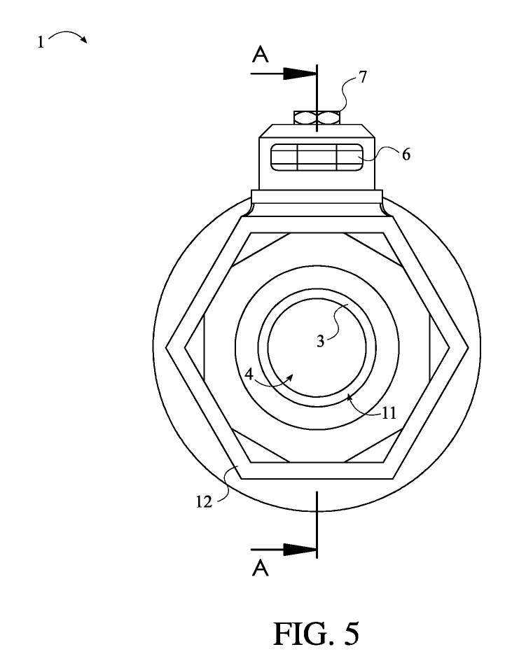

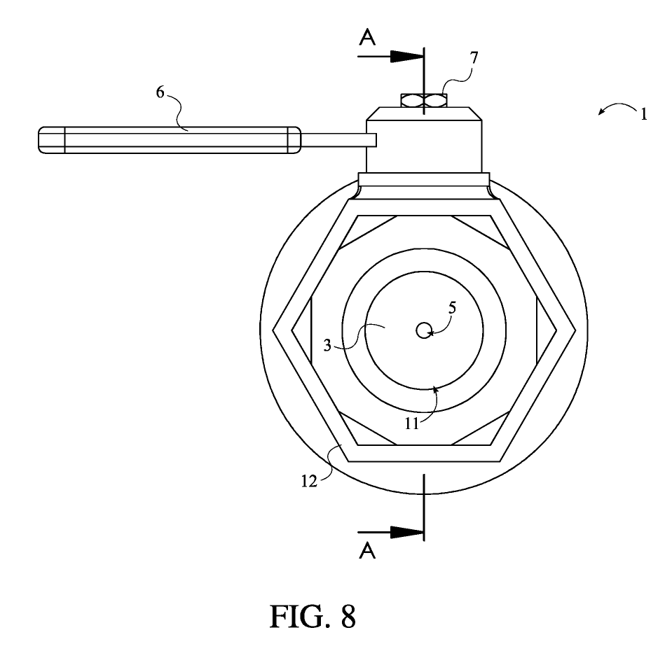

Similar to the fluid conduit 4, by rotating the ball 3, the drain hole 5 is either aligned with the outlet 11 or disjointed from the outlet 11. When the ball 3 is toggled to the open position, the drain hole 5 is positioned adjacent to a side wall of the valve body 1, or otherwise offset from the outlet 11 as shown in FIG. 5-6, wherein the side wall acts as an endcap for the drain hole 5, preventing gas or fluid from exiting the ball 3 via the drain hole 5. On the other hand, when the ball 3 is toggled to the open position, the drain hole 5 is positioned adjacent to the outlet 11 as shown in FIG. 8-9, wherein residual gas or liquid can escape from the valve chamber 12 and the fluid conduit 4 via the drain hole 5.

In the preferred embodiment of the present invention, the drain hole 5 is concentric with the outlet 11 when the ball 3 is in the closed position, as shown in FIG. 8. When the ball 3 is rotated from the open position to the closed position, the residual liquid in the fluid conduit 4 that is above the drain hole 5 will empty out of the drain hole 5 and through the outlet 11. This will increase the amount of air relative to the amount of liquid within the fluid conduit 4, thus minimizing the pressure buildup caused by freezing liquid. Instead of freezing and expanding into the inner walls of the ball like in a traditional ball 3, the liquid may expand into the air filled portion of the fluid conduit 4 or the drain hole 5.

In other embodiments of the present invention, the drain hole 5 may by angularly offset, or otherwise offset or displaced, from the outlet 11 when the ball 3 is in the closed position. For example, the drain hole 5 may be oriented downwards, thus allowing more residual liquid to be emptied from the fluid conduit 4 when the ball 3 is displaced to the closed position. No matter the orientation of the drain hole 5, as long as the drain hole 5 is open to the outlet 11 when the ball 3 is in the closed position, the drain hole 5 will relieve air pressure towards the exit side of the valve body 1 when the ball 3 is in the closed position.

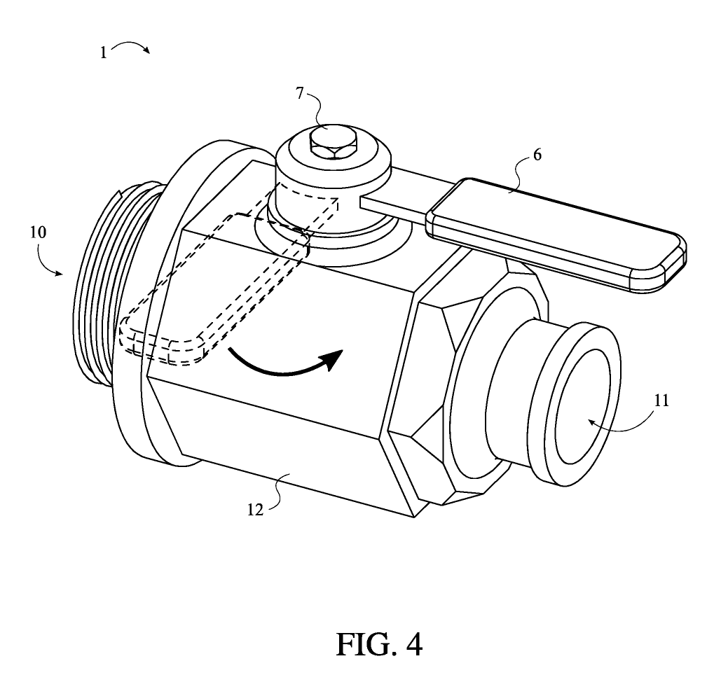

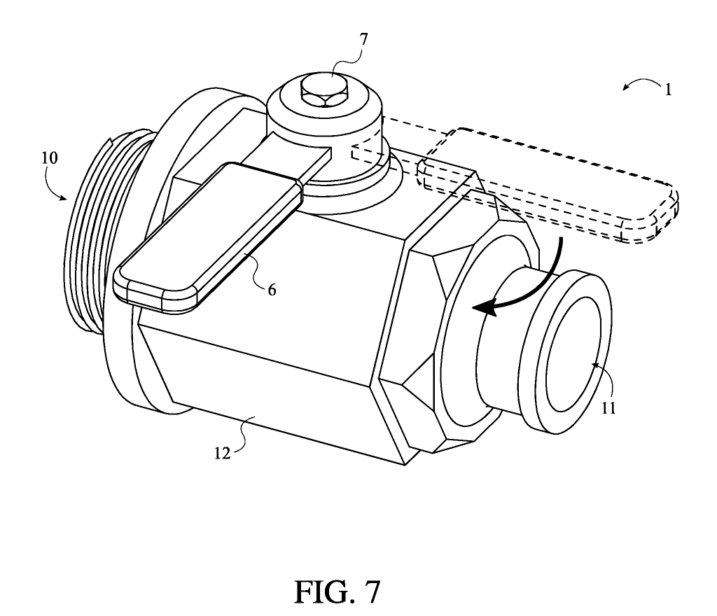

To toggle the ball 3, the lever handle 6 is manipulated in either a clockwise or counter-clockwise direction. The lever handle 6 is turned in a first direction, as shown in FIG. 4, to toggle the ball 3 to the open position, and turned in a second direction, opposite to the first direction as shown in FIG. 7, to toggle the ball 3 to the closed position. In turning the lever handle 6 in the first direction, the fluid conduit 4 is aligned with the inlet 10 and the outlet 11, while the drain hole 5 is positioned adjacent to the side wall of the valve body 1, as shown in FIG. 6. In this way, the gas or liquid is able to flow freely from the inlet 10 to the outlet 11, through the fluid conduit 4. Meanwhile, the drain hole 5 is capped off by the side wall of the valve body 1, thus preventing gas or liquid from escaping the fluid conduit 4 into the valve chamber 12.

In turning the lever handle 6 in the second direction, the fluid conduit 4 is disjointed from the inlet 10 and the outlet 11, while the drain hole 5 is positioned adjacent to the outlet 11, as shown in FIG. 9. In this way, the gas or liquid flowing from the inlet 10 is unable to enter the fluid conduit 4 and the ball 3 prevents any gas or liquid from passing through the inlet 10 into the valve chamber 12. Meanwhile, the residual gas or liquid in the fluid conduit 4 is at least partially released through the drain hole 5, thus preventing excessive pressure buildup in the fluid conduit 4 due to freezing liquid.

In the preferred embodiment of the present invention, the handle lever is operably coupled to the ball 3 through the stem 7. In reference to FIG. 6 and FIG. 9, the stem 7 traverses through the valve body 1 and engages with the ball 3, while the lever handle 6 is terminally connected to the stem 7, opposite the ball 3. In this way, the stem 7 transfers the rotational motion of the lever handle 6 to the ball 3, thus allowing a user to manipulate the internal configuration of the ball 3.

In one embodiment, a slot is formed into the ball 3, as shown in FIG. 1. The stem 7 is positioned into the slot, wherein at least one flat surface of the stem 7 engages with at least one flat surface of ball 3 formed by the slot. Thus, when the lever handle 6 is rotated, the stem 7 is also rotated, wherein the flat surface of the stem 7 applies a force to the flat surface of the ball 3, causing the ball 3 to rotate in the corresponding direction. In other embodiments, the stem 7 may be permanently fixed to the ball 3, or connected in any other manner that allows the rotational motion of the lever handle 6 to be transferred to the ball 3.

The present invention can be configured to form any type of ball valve. For example, in some embodiments the present invention is configured as a floating ball valve, wherein the ball 3 is a floating ball, held only in place by the seat 2. Meanwhile, in other embodiments the present invention may be configured as a trunnion ball valve, wherein the ball 3 is a trunnion ball and is rotatably anchored to the valve body 1. The specific type of ball into which the present invention is configured largely depends on the specifications of the system 7 in which the present invention is to be used. However, the benefits of the drain hole 5 can be observed in any type of system 7.

Similarly, the fluid conduit 4 can be shaped and sized differently from one embodiment to another in order to form different style ball valves. For example, in some embodiments the fluid conduit 4 is a full port, wherein the diameter of the fluid conduit 4 matches the diameter of the pipeline in which the present invention is installed. Meanwhile, in other embodiments, the fluid conduit 4 may be a reduced port, wherein the diameter of the fluid conduit 4 is less than the diameter of the pipeline in which the present invention is installed. In yet other embodiments of the present invention, the fluid conduit 4 may be a V port to allow for more linear flow characteristics.

In the preferred embodiment, the present invention is a two-way ball valve, wherein the fluid conduit 4 is a linear channel that traverses through the ball 3. However, the fluid conduit 4 can also be L-shaped, or otherwise curved or bent, if the present invention is to be positioned in between two pipes that are not collinear. Furthermore, in other embodiments the present invention can be configured as three-way valve, four-way valve, etc.; the fluid conduit 4 may be linear, L-shaped, T-shaped, or configured in any other manner to accommodate the number of inlets and outlets and the desired flow paths.

Although the invention has been explained in relation to its preferred embodiment, it is to be understood that many other possible modifications and variations can be made without departing from the spirit and scope of the invention as hereinafter claimed.

What is claimed is:

1. A pressure relief ball valve comprises:
a valve body comprising an inlet, an outlet, and a valve chamber;
the valve chamber being positioned in between the inlet and the outlet;
a ball being rotatably mounted within the valve chamber;
a fluid conduit traversing through the ball;
a drain hole traversing into the ball;
the drain hole being angularly offset from the fluid conduit;
the drain hole being in fluid communication with the fluid conduit;
a lever handle being operably coupled to the ball;
the ball being configurable between an open position and a closed position through the lever handle;
the drain hole being offset from the outlet when the ball is in the open position;
the fluid conduit being in fluid communication with the inlet and the outlet when the ball is in the open position;
the drain hole being positioned adjacent to the outlet when the ball is in the closed position; and
the fluid conduit being disjointed from the inlet and the outlet when the ball is in the closed position.

2. The pressure relief ball valve as claimed in claim 1 comprises:
the drain hole being perpendicular to the fluid conduit.

3. The pressure relief ball valve as claimed in claim 1 comprises:
a stem traversing through the valve body;
the stem being engaged with the ball; and
the lever handle being terminally connected to the stem opposite the ball.

4. The pressure relief ball valve as claimed in claim 1 comprises:
a seat being mounted within the valve chamber; and
the ball being nested in the seat.

5. The pressure relief ball valve as claimed in claim 1, wherein the ball is a floating ball.

6. The pressure relief ball valve as claimed in claim 1, wherein the ball is a trunnion ball.

7. The pressure relief ball valve as claimed in claim 1, wherein the fluid conduit is a full port.

8. The pressure relief ball valve as claimed in claim 1, wherein the fluid conduit is a reduced port.

9. The pressure relief ball valve as claimed in claim 1, wherein the fluid conduit is a V port.

10. A pressure relief ball valve comprises:
a valve body comprising an inlet, an outlet, and a valve chamber;
the valve chamber being positioned in between the inlet and the outlet;
a seat being mounted within the valve chamber;
the ball being rotatably nested in the seat;
a fluid conduit traversing through the ball;
a drain hole traversing into the ball;
the drain hole being angularly offset from the fluid conduit;
the drain hole being in fluid communication with the fluid conduit;
a stem traversing through the valve body;
the stem being engaged with the ball;
a lever handle being terminally connected to the stem opposite the ball;
the ball being configurable between an open position and a closed position through the lever handle;
the drain hole being offset from the outlet when the ball is in the open position;
the fluid conduit being in fluid communication with the inlet and the outlet when the ball is in the open position;
the drain hole being positioned adjacent to the outlet when the ball is in the closed position;
the fluid conduit being disjointed from the inlet and the outlet when the ball is in the closed position;

11. The pressure relief ball valve as claimed in claim 10 comprises:
the drain hole being perpendicular to the fluid conduit;

12. The pressure relief ball valve as claimed in claim 10, wherein the ball is a floating ball.

13. The pressure relief ball valve as claimed in claim 10, wherein the ball is a trunnion ball.

14. The pressure relief ball valve as claimed in claim 10, wherein the fluid conduit is a full port.

15. The pressure relief ball valve as claimed in claim 10, wherein the fluid conduit is a reduced port.

16. The pressure relief ball valve as claimed in claim 10, wherein the fluid conduit is a V port.
